(19) United States
(12) Patent Application Publication
(10) Pub. No.: US 2007/0134076 A1
(43) Pub. Date: Jun. 14, 2007

(54) Carrier transferring load and unload system of low frame bridge type between the shore side crane and the stack field crane

(76) Inventor: Hong Tian, Shanghai (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/360,463

(22) Filed: Feb. 23, 2006

(30) Foreign Application Priority Data
Dec. 14, 2005 (CN) 200510111464.0

(51) Int. Cl. B65G 67/60

(52) U.S. Cl. 414/139.4

(57) ABSTRACT

A carrier transferring load and unload system of low frame bridge type between the shore side crane and the stack field crane, wherein said system comprises: at least one low frame bridge which being arranged under the back extension distance of the shore side crane and parallel to the crane large carrier rail; at least one set of rail extending along the length direction of the low frame bridge being arranged at the top and middle parts of each low frame bridge respectively; a low frame bridge crane carrier being arranged on the top rail and traveling along the rail; a low frame bridge plate carrier being arranged on the middle rail and traveling along the rail; the low frame bridge crane carrier and the low frame bridge plate carrier can travel across each other; the ground rails perpendicular to the length direction of the low frame bridge being arranged under the low frame bridge at the position corresponding to each stacking container area and being extended to load and unload area of the sea side end part of the stack field; and the ground plate carrier being arranged on each ground rail respectively and traveling along the rail. The invention increases the load and unload efficiency of the container stock significantly and may realize the semi-automation and automation of the load and unload of the container stock.

### CROSS-REFERENCE TO RELATED APPLICATION

This application claims priority to Chinese Patent Application Number CN200510111464.0, filed on Dec. 14, 2005, the content of which is incorporated in its entirety by reference herein.

### FIELD OF THE INVENTION

The present invention relates to load and unload technology of the container dedicate dock, more particularly, relates to a carrier transferring load and unload system of the low frame bridge type between the shore side crane and the stack field crane.

### BACKGROUND OF THE INVENTION

Between the shore side crane and the stack field crane of the container dock, the containers need be transferred so that the tremendous quantity of container which need be transported by ships is transferred from the container stack field onto the container transportation ships, or the tremendous quantity of containers carried thereto by the container transportation ships is transferred from the container transportation ships onto the container stack field. In the prior art, the operation is carried out by horizontal transportation car (container truck or AGV or strike transportation car) driven by combustion engine. When the horizontal transportation cars are traveling, the cross interference of the several transportation cars is easy to occur, the distance of the transportation is too wide, therefore the transportation efficiency is affected. In order to increase the load and unload efficiency, the amount of the transportation cars need be increased, and the more the amount of the transportation cars, the larger is the possibility of the cross interference. Hence, it is impossible to increase the load and unload efficiency by virtue of increasing the amount of the transportation cars. It is eager to develop a high efficient container load and unload system in order to meet the requirements of dock load and unload productivity by the large scale and the high speed automation of the container transportation.

### SUMMARY OF THE INVENTION

In one aspect of the invention, providing a high efficient carrier transferring load and unload system of the low frame bridge type between the shore side crane and the stack field crane in order to meet the requirements of dock load and unload productivity by the large scale and the high speed automation of the container transportation.

According to the present invention, providing a carrier transferring load and unload system of low frame bridge type between the shore side crane and the stack field crane, wherein said system comprises: at least one low frame bridge which being arranged under the back extension distance of the shore side crane and parallel to the crane large carrier rail; at least one set of rail extending along the length direction of the low frame bridge being arranged at the top and middle parts of each low frame bridge respectively; a low frame bridge crane carrier being arranged on the top rail and traveling along the rail; a low frame bridge plate carrier being arranged on the middle rail and traveling along the rail; the low frame bridge crane carrier and the low frame bridge plate carrier can travel across each other; the ground rails perpendicular to the length direction of the low frame bridge being arranged under the low frame bridge at the position corresponding to each stacking container area and being extended to load and unload area of the sea side end part of the stack field; and the ground plate carrier being arranged on each ground rail respectively and traveling along the rail.

In said carrier transferring load and unload system of the low frame bridge type between the shore side crane and the stack field crane, the length of said low frame bridge is corresponding to the dimension of the stacking container area of the stack field.

In said carrier transferring load and unload system of the low frame bridge type between the shore side crane and the stack field crane, the platform on said ground plate carrier can turn around 90 degrees.

In said carrier transferring load and unload system of the low frame bridge type between the shore side crane and the stack field crane, there is one said low frame bridge.

In said carrier transferring load and unload system of the low frame bridge type between the shore side crane and the stack field came, the four low frame bridge are arranged tightly in parallel.

In said carrier transferring load and unload system of the low frame bridge type between the shore side crane and the stack field crane, the three low frame bridge are arranged tightly in parallel.

In said carrier transferring load and unload system of the low frame bridge type between the shore side crane and the stack field crane, the two low frame bridge are arranged tightly in parallel.

By using the carrier transferring load and unload system of the low frame bridge type between the shore side crane and the stack field crane according to the invention, the load and unload efficiency of the container stock is increased significantly, the semi-automation and automation of the load and unload of the container dock can be realized, the construction difficulty and the cost of the container automation dock are decreased significantly, not only it can be used in the non-automation dock, but also it is specifically suited for the automation dock.

### BRIEF DESCRIPTION OF THE APPENDED DRAWINGS

It is possible to understand the object, specific structure features and advantages of the invention further from the following description of the preferred embodiments of the invention referring to the appended drawings wherein:

FIG. 1 is the schematic front view of the structure the carrier transferring load and unload system of low frame bridge type between the shoe side crane and the stack field crane according to the invention;

FIG. 2 is the top view of the FIG. 1;

FIG. 3 is the side view of the FIG. 1; and

FIG. 4 is the schematic structure view of the low frame bridge according to invention.

### DETAILED DESCRIPTION OF PREFERRED EMBODIMENTS

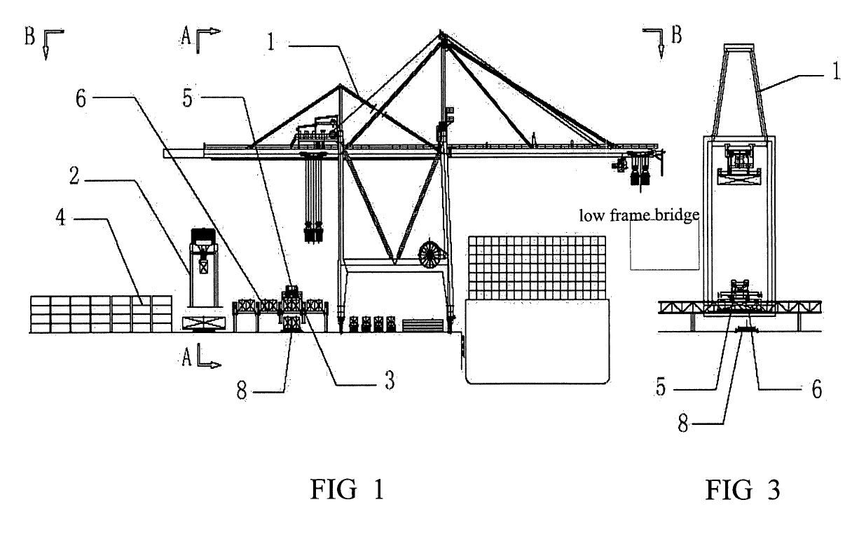

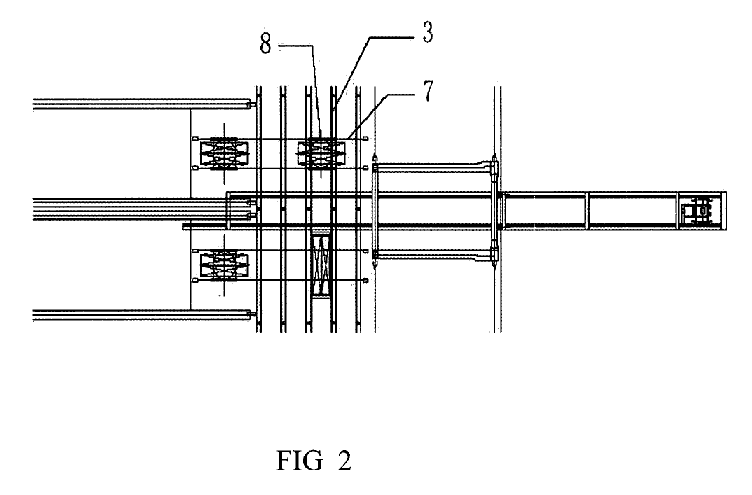

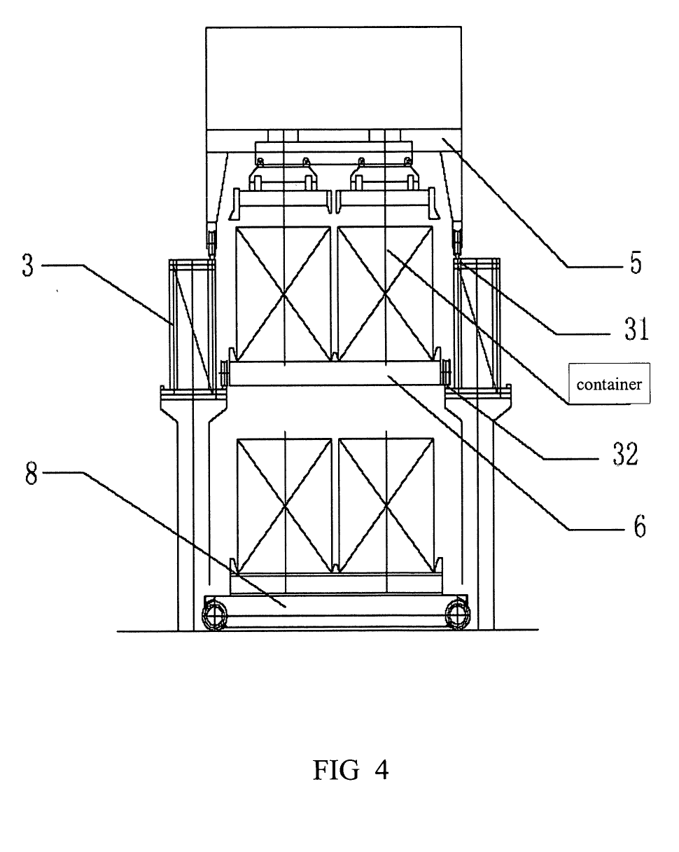

Referring to FIGS. 1, 2 and 3, the carrier transferring load and unload system of low frame bridge type between the shoe side crane and the stack field crane according to the invention includes the low frame bridge 3 which is arranged under the back extension distance of the shore side crane and parallel to the crane large carrier rail. The length of the low frame bride 3 is corresponding to the dimension of the stacking container area of the stack field and its width is matched to the width of the travel carrier, and the amount of the low frame bridge 3 may be one, two, three, four or more, there are four low frame bridge in the embodiment. When the amount is more than one, the low frame bridges are arranged tightly in parallel.

Referring 4 and 1, a set of the rail 31 extending in the length direction of the low frame bridge is arranged at the top part of each low frame bridge 3 and a set of the rail 32 extending in the length direction of the low frame bridge is arranged at the middle part of the bridge, and the two rail 31 and 32 are arranged in parallel. The low frame bridge crane carrier 5 is arranged on the top rail 31 and may travel along the rail, the low frame bridge plate carrier 6 is arranged on the middle rail 32 and may travel along the rail. When the low frame crane carrier 5 is traveling on the top rail 31, the travel of the low frame bridge plate carrier 6 with container on the middle rail is not affected, that is, the low frame crane carrier 5 and the low frame bridge, that is, the low frame crane carrier 5 and the low frame bridge plate carrier 6 with of without container may travel across each other. The ground rile 7 are arranged under the low frame bridge 3 and corresponding to each stacking container area and perpendicular to the length direction of the low frame bridge and extended to the load and unload area of the sea side end part of the stack field 4. The ground plate carrier 8 is arranged on each ground rail 7 respectively and may travel along the rail, and the platform on the ground plate carrier may turn around go degrees. Therefore, the container carried on the platform may be turned go degrees in the turn operation.

The operation of the carrier transferring load and unload system of low frame bridge type between the shore side crane and the stack field crane according to the invention will be described referring to FIG. 1 as follows.

When unloading containers from ship, the containers are transferred first by the shore side crane from ship onto the low frame bridge plate carrier, then the low frame bridge plate carrier is displaced to load and unload position, the containers are suspended and placed by the low frame bridge crane carrier above the low frame bridge plate carrier onto the designated ground plate carrier, then the ground plate carrier is displaced to the load and unload area of the stack field end part after receiving the containers, at same time the containers are turned around go degrees on the ground plate carrier, finally the containers is transferred onto the stacking container area by the stack field crane.

When loading containers onto ship, the containers are transferred from the stack field area onto the ground plate carrier by the stack field crane, then the ground plate carrier is displaced to the area under the low frame bridge after receiving containers, at same time the containers are turned around go degrees on the ground plate carrier, after arriving the area under the low frame bridge, the containers are suspended and placed onto the low frame bridge plate carrier by the low frame bridge crane carrier, then the low frame bridge plate carrier is traveled to the load and unload position, finally the containers are suspended and placed from the low frame bridge plate carrier onto ship by the shore side crane

The carrier transferring load and unload system of low frame bridge type between the shore side crane and the stack field crane according to the invention has abandoned the traditional horizontal transportation car load and unload technology driven by combustion engine in the container dock, and has used cleverly the low frame bridge and carriers arranged at the high and low positions on the low frame bridge as well as the matched ground carriers, and has soloed excellently the horizontal cross interference problem when the containers are horizontally transported between the shore side crane and the stack field crane, has increased significantly the load and unload speed between the shore side crane and the stack field crane, and has provided reasonably the rapid transfer between the shore side crane and the stack field crane. The system has very large economical benefit and social benefit.

1. A carrier transferring load and unload system of low frame bridge type between the shore side crane and the stack field crane, wherein said system comprises:
at least one low frame bridge which being arranged under the back extension distance of the shore side crane and parallel to the crane large carrier rail;
at least one set of rail extending along the length direction of the low frame bridge being arranged at the top and middle parts of each low frame bridge respectively, a low frame bridge crane carrier being arranged on the top rail and traveling along the rail;
a low frame bridge plate carrier being arranged on the middle rail and traveling along the rail; the low frame bridge crane carrier and the low frame bridge plate carrier can travel across each other;
the ground rails perpendicular to the length direction of the low frame bridge being arranged under the low frame bridge at the position corresponding to each stacking container area and being extended to load and unload area of the sea side end part of the stack field; and
the ground plate carrier being arranged on each ground rail respectively and traveling along the rail.

2. The system of claim 1, wherein the length of said low frame bridge is matched to the dimension of the stacking container area of the stack field.

3. The system of claim 1, wherein platform on said ground plat carrier can turn around 90 degrees.

4. The system of claim 1, wherein there is a said low frame bridge.

5. The system of claim 1, wherein there are four said low frame bridges, the four low frame bridges are arranged tightly in parallel.

6. The system of claim 1, wherein there are three said low frame bridges, the three low frame bridges are arranged tightly in parallel.

7. The system of claim 1, wherein there are two said low frame bridges, the two low frame bridges are arranged tightly in parallel.
